(19) United States
(12) Patent Application Publication
(10) Pub. No.: US 2009/0307304 A1
(43) Pub. Date: Dec. 10, 2009

(54) Method for Server Side Aggregation of Asynchronous, Context - Sensitive Request Operations in an Application Server Environment

(75) Inventors: Maxim Avery Moldenhauer, Durham, NC (US); Erinn Elizabeth Koonce, Durham, NC (US); Todd Eric Kaplinger, Raleigh, NC (US); Rohit Dilip Kelapure, Durham, NC (US)

Correspondence Address: DUKE W. YEE, YEE & ASSOCIATES, P.C., P.O. BOX 802333, DALLAS, TX, 75380, US

(73) Assignee: INTERNATIONAL BUSINESS MACHINES CORPORATION, Armonk, NY (US)

(21) Appl. No.: 12/136,185

(22) Filed: Jun. 10, 2008

(51) Int. Cl. G06F 15/16

(52) U.S. Cl. 709/203

(57) ABSTRACT

Process, apparatus and program product for processing a request at an application server are provided. The process includes initiating one or more asynchronous operations in response to the request received by the application server. The process further includes generating a response content that includes one or more placeholders. Thereafter, one or more placeholders mark a location of content corresponding to each of the one or more asynchronous operations. The process further includes aggregating content received from a completed asynchronous operation by filling the content in the corresponding placeholder. The process further includes sending a partial response content with content up to the first unfilled placeholder.

### FIELD OF THE INVENTION

The present invention generally relates to an application server environment and more specifically, to processing of a request at the application server.

### BACKGROUND OF THE INVENTION

An application server is a server program running on a computer in a distributed network that provides business logic for application programs. Clients are traditionally used at an end user system for interacting with the application server. Usually, the client is an interface such as, but not limited to, a web browser, a Java-based program, or any other web-enabled programming application.

The clients may request the application server for certain information. Such requests may require processing of multiple asynchronous operations. The application server may then execute these asynchronous operations to generate content corresponding to these operations.

The client could aggregate the content generated by the application server. However, for the client to aggregate the content, the client must have access to technologies like JavaScript and Browser Object Model (BOM), etc. Thus, in cases where the clients do not have accessibility to such technologies, the content is aggregated at the server. Moreover, a main request processing thread on which the request is received at the application server has to wait till the application server completes all asynchronous operations corresponding to that request. Also, in some other cases the request may even require synchronous operations to be performed along with multiple asynchronous operations.

Some earlier solutions disclose the concept of processing asynchronous operations that allow the main request processing thread to exit. However, such solutions do not disclose processing multiple asynchronous operations concurrently when the content needs to be aggregated at the application server. Also, none of the proposed solutions address handling both synchronous and asynchronous operations.

In accordance with the foregoing, there is a need for a solution, which provides handling of requests that require processing of both multiple asynchronous operations and synchronous operations with the content being aggregated at the application server.

### BRIEF SUMMARY OF THE INVENTION

A computer implemented process for processing a request at an application server is provided. The process includes initiating one or more asynchronous operations in response to the request received by the application server. The process further includes generating a response content that includes one or more placeholders. The one or more placeholders mark a location of content corresponding to each of the one or more asynchronous operations. The process further includes aggregating the content received from a completed asynchronous operation by filling the content in the corresponding placeholder. The process further includes sending a partial response content with content up to the first unfilled placeholder.

A programmable apparatus for processing a request at an application server is also provided. The apparatus includes programmable hardware connected to a memory. The apparatus further includes a program stored in the memory that directs the programmable hardware to perform the step of initiating one or more asynchronous operations in response to a request for information by, for example, a client, and subsequently generating a response content corresponding to the request, that includes one or more placeholders. The one or more placeholders mark a location of content corresponding to each of the one or more asynchronous operations. The program further directs the programmable hardware to perform the step of aggregating the content received from a completed asynchronous operation by filling the content in the corresponding placeholder. The program further directs the programmable hardware to perform the step of sending a partial response content with content up to the first unfilled placeholder.

A computer program product for causing a computer to process a request at an application server is also provided. The computer program product includes a computer readable storage medium. The computer program product further includes a program stored in the computer readable storage medium. The computer readable storage medium, so configured by the program, causes a computer to perform the step of initiating one or more asynchronous operations in response to the request. The computer is further configured to perform the step of generating a response content, that includes one more placeholders, corresponding to the request. The one or more placeholders mark a location of content corresponding to each of the one or more asynchronous operations. The computer is further configured to perform the step of aggregating the content received from a completed asynchronous operation by filling the content in the corresponding placeholder. The computer is further configured to perform the step of sending a partial response content with content up to the first unfilled placeholder.

### BRIEF DESCRIPTION OF THE SEVERAL VIEWS OF THE DRAWINGS

FIG. 1 illustrates an application server environment in accordance with an embodiment of the present invention;

FIG. 2 is a flowchart depicting a process for processing of a request in accordance with an embodiment of the present invention;

FIG. 3 is a flowchart depicting a process for processing of the request in accordance with another embodiment of the present invention; and

FIG. 4 is a block diagram of an apparatus for processing of the request in accordance with an embodiment of the present invention.

### DETAILED DESCRIPTION

The invention would now be explained with reference to the accompanying figures. Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

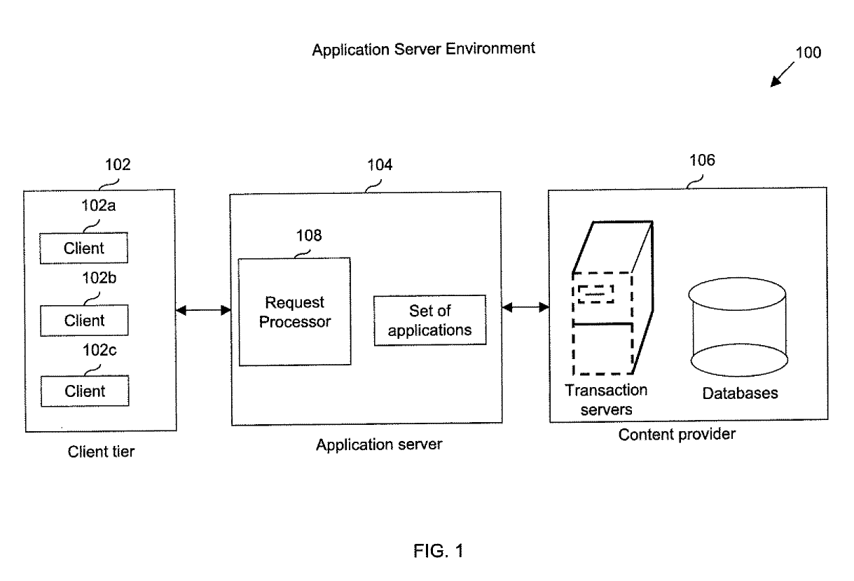

FIG. 1 illustrates application server environment 100 in accordance with various embodiment of the present invention. Application server environment 100 is shown as a three-tier system comprising client tier 102, application server 104, and content provider 106. Client tier 102 represents an interface at end user systems that interacts with application server 104. Usually, the interface is, but not limited to, a web browser, a Java-based program, or any other Web-enabled programming application. There may be multiple end users and each end user may have a client, thus client tier 102 shown in the FIG. 1 represents one or more clients 102a, 102b, and 102c, which interact with application server 104 for processing of their requests. Application server 104 hosts a set of applications to support requests from client tier 102. Application server 104 communicates with content provider 106 for extracting various information required by, for example, client 102a corresponding to the request (herein after interchangeably referred to as main request) sent by client 102a. It will be apparent to a person skilled in the art that any application server and client may be used within the context of the present invention without limiting the scope of the present invention. Content provider 106 includes databases and transaction servers for providing content corresponding to the request. Application server 104 interacts with content provider 106 through request processor 108 for processing of various operations corresponding to the request sent by client 102a.

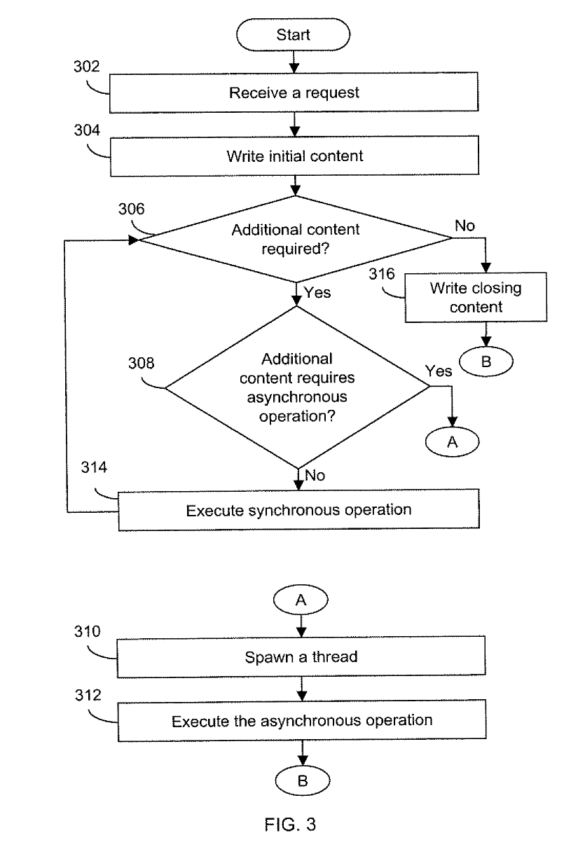

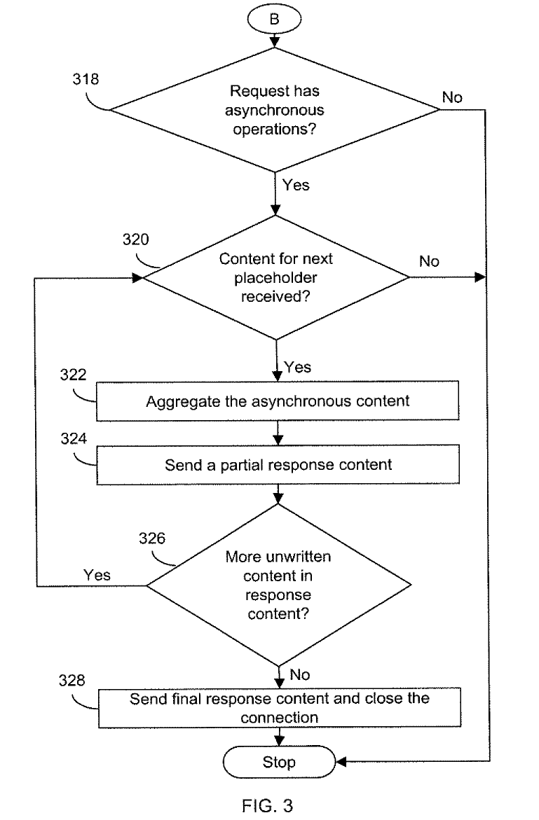

Request processor 108 is a program that executes business logic on application server 104. In an embodiment of the present invention, request processor 108 is a servlet. Request processor 108 may receive a request from, for example, client 102a; dynamically generate the response thereto; and then send the response in the form of, for example, an HTML or XML document to client 102a. In one embodiment of the present invention, the request can be a combination of synchronous and one or more asynchronous operations. The request sent by client 102a is handled by a main request processing thread of request processor 108. The main request processing thread generates a response content and writes an initial content. Subsequently, the main request processing thread checks if any additional content is required for the completion of the response. The additional content may require a combination of multiple synchronous and asynchronous operations. The main request processing thread executes the synchronous operations and, as needed, spawns a new thread for each of the one or more asynchronous operations. In an embodiment of the present invention, each of the spawned threads interacts with content provider 106 for processing the asynchronous operations. Once the processing of the asynchronous operation completes, each spawned thread proceeds to an aggregation callback function for aggregating content generated by the completed asynchronous operation and sending a partial response content to client 102a. The aggregation callback function is described in detail with reference to FIG. 3 of this application

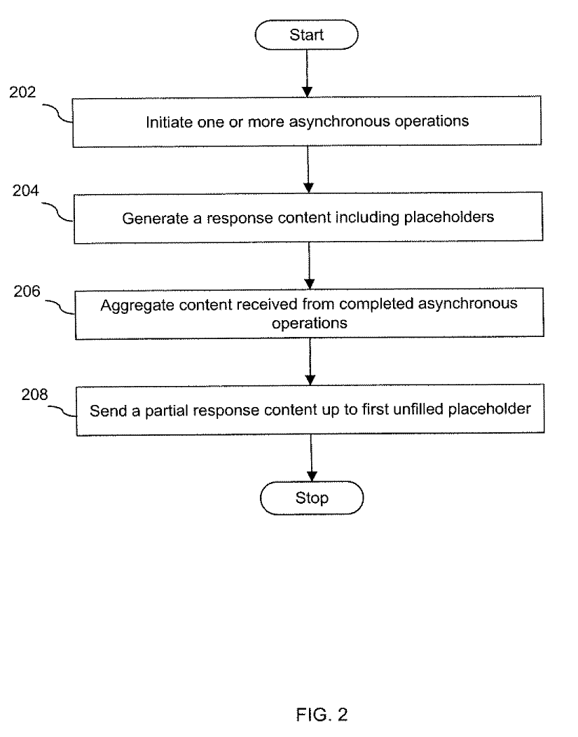

FIG. 2 is a flowchart depicting a process for processing of a request in accordance with an embodiment of the present invention. In an embodiment of the present invention, application server 104 receives a request from client 102a. The request initializes request processor 108 at application server 104. In an embodiment of the present invention, the request may comprise several synchronous and asynchronous operations. At step (202), the main request processing thread of request processor 108 initiates one or more asynchronous operations corresponding to the request sent by client 102a. For initiating the one or more asynchronous operations, the main request processing thread spawns a thread corresponding to each asynchronous operation. By spawning a thread corresponding to each asynchronous operation, the main request processing thread is freed up to handle more requests from the client. The content of the asynchronous operations corresponding to each spawned thread is generated and stored in a spawned thread buffer. Subsequently, at step (204), a response content is generated in response to the request sent by the client 102a. The response content includes one or more placeholders for presenting content corresponding to each of the one or more asynchronous operations. The asynchronous operation itself drives the aggregation of its response content and any other content of preceding placeholders, if those are finished, and that is why the main request processing thread is freed up. In an embodiment of the present invention, as and when one or more asynchronous operations complete, at step (206), content received from a completed asynchronous operation is aggregated by filling the content in the corresponding placeholder. In other words, the content of each spawned thread buffer is filled in its respective placeholder in the response content. The aggregation at step (206) is event driven; and the content corresponding to various asynchronous operations is aggregated as and when they complete. In an embodiment of the present invention, while the aggregation of step (206) is in progress, the main request processing thread may proceed to step (208), where a partial response content is sent to client 102a up to the first unfilled placeholder. In other words, the partial response content sent to client 102a will include all content up to the next placeholder that is waiting to be filled (i.e. corresponding asynchronous operation is still continuing). Thus, client 102a does not have to perform any content aggregation; and the content aggregation occurs at application server 104 in a manner that is transparent to client 102a. After sending the partial response content, the main request processing thread may exit. Alternatively, the main request processing thread may return to handle additional requests from client tier 102.

FIG. 3 is a flowchart depicting a process for processing of the request in accordance with another embodiment of the present invention. At step (302) application server 104 receives the request by client 102a. In an exemplary embodiment of the present invention, the request may be in the form of an HTTP request for a webpage. The request initializes request processor 108 at application server 104. The request may include a combination of synchronous operations and asynchronous operations that are processed by request processor 108.

At step (304), the main request processing thread writes an initial content in the response content. In an embodiment of the present invention, the initial content can be a header of the webpage and/or any static content associated with the webpage. The response content resides on application server 104 and is generated in response to the request received by client 102a. Subsequently, at step (306), the main request processing thread checks if additional content is required in the response content. If additional content is required, then at step (308), the main request processing thread checks if the additional content requires an asynchronous operation. In case an asynchronous operation is required, then the main request processing thread initiates execution of the asynchronous operation.

FIG. 3 further depicts execution of the asynchronous operation. At step (310), the main request processing thread spawns a thread for processing the asynchronous operation. Further, a placeholder is marked in the response content corresponding to the asynchronous operation. The placeholder is a location in the webpage for a content corresponding to the asynchronous operation. The main request processing thread also propagates context information corresponding to the asynchronous operation to the spawned thread. Subsequently, at step (312), the spawned thread begins processing of the asynchronous operation. Upon completion of the asynchronous operation, the spawned thread proceeds to the aggregation callback function.

In an exemplary embodiment of the present invention, there are three different asynchronous operations, hereinafter referred as asynchronous operation 1, asynchronous operation 2, and asynchronous operation 3. A person skilled in the art can understand that this example is taken merely for explanation purposes and does not limit the number of asynchronous operations associated with any such request. In an exemplary embodiment of the present invention, steps (310) and (312) are performed for each asynchronous operation. After initiating the asynchronous operation 1, the main request processing thread checks again at step (306), if additional content is required in the response content. Thereafter, the main request processing thread checks at step (308), if the additional content requires another asynchronous operation. Subsequently, if the next operation is also an asynchronous operation (say asynchronous operation 2), then again step (310) and step (312) are performed to initiate the asynchronous operation 2. In a similar manner as explained, the asynchronous operation 3 also gets initiated. As and when an asynchronous operation is initiated, a placeholder is marked in the response content corresponding to the initiated asynchronous operation.

FIG. 3 further depicts an embodiment of the present invention where the response of step (308) indicates that the additional content requires a synchronous operation. Subsequently at step (314), the main request processing thread executes the synchronous operation. The main request processing thread writes the synchronous content, generated by the synchronous operation, in the response content. After writing the synchronous content, the main request processing thread again checks at step (306), if the additional content is required for the response content. In an embodiment of the present invention there can be many synchronous operations within the request, which are performed by the main request processing thread in a similar manner as, explained above.

FIG. 3 further depicts an embodiment of the present invention where the response of step (306) indicates that no additional content is required for the response content. Thereafter, at step (316), the main request processing thread writes a closing content in the response content. In an embodiment of the present invention, the closing content is a footer of the webpage.

FIG. 3 further depicts the aggregation callback function, in accordance with an embodiment of the present invention. The aggregation callback function described hereinafter is called by the main processing thread or any of the spawned threads once they complete their operations. For describing the aggregation callback function, we use the term “calling thread” to refer to any thread (either the main request processing thread or any of the spawned threads) that has called the callback function. The aggregation callback function aggregates asynchronous content, and sends the partial response content up to the first unfilled placeholder to client 102a, according to the process described below. At step (318), the calling thread checks if the request has any asynchronous operations. If yes, then at step (320), the calling thread checks if the content for the next placeholder is received. If at step (320) it is determined that the content for the next placeholder is not received, then the calling thread exits. However, in various embodiments the calling thread sends partial response content to client 102a before exiting, thereby sending all synchronous content up to the next placeholder. On the other hand, if step (320) confirms that the content for the next placeholder is received, then the calling thread further aggregates the content at step (322). Subsequently, at step (324) the calling thread sends partial response content to client 102a, including the content of the next placeholder. Now, the calling thread checks at step (326), if there are any unwritten content in the response content. If yes, then the calling thread again checks at step (320), if the content corresponding to the next placeholder is received. If yes, then the calling thread again performs the steps (322), (324) and (326). However, if at step (320), it is determined that the content is not received, then the calling thread exits. On the other hand, if at step (326) it is determined that there is no unwritten content left in the response content, then the calling thread sends a final response content at step (328) and closes the connection. In other words, if all the asynchronous operations has completed before the completion of the processing of the calling thread, then the calling thread sends a final response content.

FIG. 3 is now used to illustrate the working of an embodiment of the present invention with the help of an example where the calling thread is a spawned thread. At step (318), the calling thread checks if there are any asynchronous operations in the request. Subsequently, at step (320), the calling thread checks if the content for the next placeholder is received for aggregation. If the received content corresponds to the next placeholder, then at step (322), the calling thread aggregates the received content at application server 104. In this embodiment of the present invention, the placeholders are filled in a same sequence as their corresponding asynchronous operations are initiated. In another embodiment of the present invention, application server 104 may configure this sequence or happen in the order the asynchronous operations finish. For example, if the asynchronous operation 2 is completed, but the asynchronous operation 1 is still pending, then the calling thread does not aggregate the content corresponding to the asynchronous operation 2 but stores the content in the calling thread buffer (corresponding to the completed asynchronous operation 2) at application server 104. Later, when the asynchronous operation 1 completes, the calling thread aggregates the content corresponding to the asynchronous operation 1 in the response content. Further, at step (324), the calling thread that has completed the asynchronous operation 1 sends out a partial response content to client 102a up to the aggregated content of asynchronous operation 1. Thereafter, the calling thread checks at step (326), if any content is left to be written in the response content. If yes, then the calling thread again checks at step (320) if the content corresponding to the next placeholder is received. If yes, then the calling thread aggregates the content by filling the next placeholder at step (322). Now as explained above, content corresponding to the completed asynchronous operation 2, which is already stored in the calling thread buffer (that is the spawned thread buffer), is now aggregated. Thereafter, at step (324), the calling thread corresponding to the asynchronous operation 2 sends the partial response content to client 102a.

FIG. 3 further depicts an embodiment of the present invention, when at step (326) no content is left to be written in the response content. Thereafter, at step (328), the connection is closed as the response sent at step (324) can be considered as the final response content with the content corresponding to the last completed asynchronous operation. In an embodiment of the present invention, at step (328), any pending calling thread buffer is transferred to the response content and the calling thread corresponding to the last completed asynchronous operation (say asynchronous operation 3) sends a final response content to client 102a.

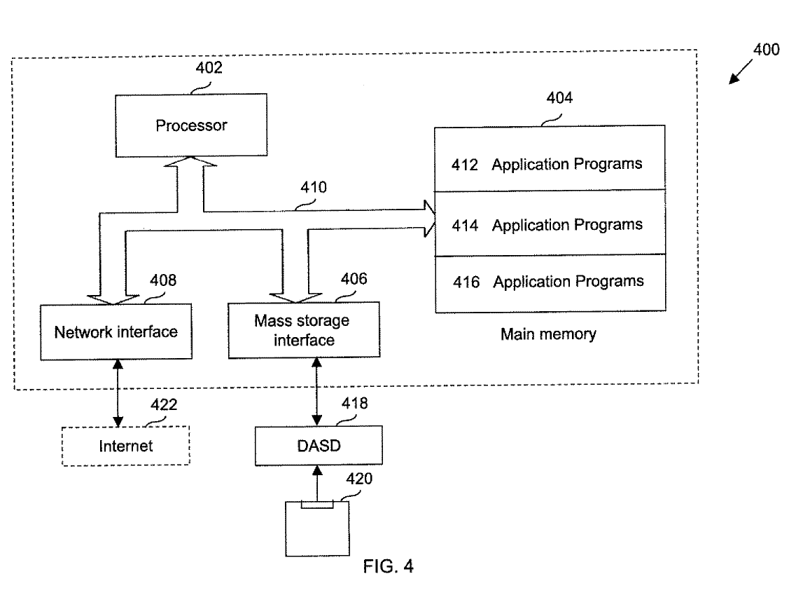

FIG. 4 is a block diagram of an apparatus for processing of the request in accordance with an embodiment of the present invention. Apparatus depicted in the FIG. 4 is computer system 400 that includes processor 402, main memory 404, mass storage interface 406, and network interface 408, all connected by system bus 410. Those skilled in the art will appreciate that this system encompasses all types of computer systems: personal computers, midrange computers, mainframes, etc. Note that many additions, modifications, and deletions can be made to this computer system 400 within the scope of the invention. Examples of possible additions include: a display, a keyboard, a cache memory, and peripheral devices such as printers.

FIG. 4 further depicts processor 402 that can be constructed from one or more microprocessors and/or integrated circuits. Processor 402 executes program instructions stored in main memory 404. Main memory 404 stores programs and data that computer system 400 may access.

In an embodiment of the present invention, main memory 404 stores program instructions that perform one or more process steps as explained in conjunction with the FIGS. 2 and 3. Further, a programmable hardware executes these program instructions. The programmable hardware may include, without limitation hardware that executes software based program instructions such as processor 402. The programmable hardware may also include hardware where program instructions are embodied in the hardware itself such as Field Programmable Gate Array (FPGA), Application Specific Integrated Circuit (ASIC) or any combination thereof.

FIG. 4 further depicts main memory 404 that includes one or more application programs 412, data 414, and operating system 416. When computer system 400 starts, processor 402 initially executes the program instructions that make up operating system 416. Operating system 416 is a sophisticated program that manages the resources of computer system 400 for example, processor 402, main memory 404, mass storage interface 406, network interface 408, and system bus 410.

In an embodiment of the present invention, processor 402 under the control of operating system 416 executes application programs 412. Application programs 412 can be run with program data 414 as input. Application programs 412 can also output their results as program data 414 in main memory 404.

FIG. 4 further depicts mass storage interface 406 that allows computer system 400 to retrieve and store data from auxiliary storage devices such as magnetic disks (hard disks, diskettes) and optical disks (CD-ROM). These mass storage devices are commonly known as Direct Access Storage Devices (DASD) 418, and act as a permanent store of information. One suitable type of DASD 418 is floppy disk drive that reads data from and writes data to floppy diskette 420. The information from the DASD can be in many forms. Common forms are application programs and program data. Data retrieved through mass storage interface 406 is usually placed in main memory 404 where processor 402 can process it.

While main memory 404 and DASD 418 are typically separate storage devices, computer system 400 uses well known virtual addressing mechanisms that allow the programs of computer system 400 to run smoothly as if having access to a large, single storage entity, instead of access to multiple, smaller storage entities (e.g., main memory 404 and DASD 418). Therefore, while certain elements are shown to reside in main memory 404, those skilled in the art will recognize that these are not necessarily all completely contained in main memory 404 at the same time. It should be noted that the term “memory” is used herein to generically refer to the entire virtual memory of computer system 400. In addition, an apparatus in accordance with the present invention includes any possible configuration of hardware and software that contains the elements of the invention, whether the apparatus is a single computer system or is comprised of multiple computer systems operating in concert.

FIG. 4 further depicts network interface 408 that allows computer system 400 to send and receive data to and from any network connected to computer system 400. This network may be a local area network (LAN), a wide area network (WAN), or more specifically Internet 422. Suitable methods of connecting to a network include known analog and/or digital techniques, as well as networking mechanisms that are developed in the future. Many different network protocols can be used to implement a network. These protocols are specialized computer programs that allow computers to communicate across a network. TCP/IP (Transmission Control Protocol/Internet Protocol), used to communicate across the Internet, is an example of a suitable network protocol.

FIG. 4 further depicts system bus 410 that allows data to be transferred among the various components of computer system 400. Although computer system 400 is shown to contain only a single main processor and a single system bus, those skilled in the art will appreciate that the present invention may be practiced using a computer system that has multiple processors and/or multiple buses. In addition, the interfaces that are used in the preferred embodiment of the present invention may include separate, fully programmed microprocessors that are used to off-load compute-intensive processing from processor 402, or may include I/O adapters to perform similar functions.

In an embodiment of the present invention, when the request like an HTTP request for a webpage is received at the server, the request processor can build the entire layout webpage by the main request processing thread. The main request processing thread builds the layout by marking placeholders corresponding to each of the one or more asynchronous operations corresponding to the request. Moreover, the main request processing thread also executes the synchronous operations corresponding to the request and writes the synchronous content in the response content. Also, when all the placeholders corresponding to the one or more asynchronous operations are marked in the response content, the main request processing thread may send a partial response content to the client up to the first unfilled placeholder. This allows the client to see as much as possible and as soon as possible, and also the main thread may exit to handle additional clients request.

Further, when any of the asynchronous operation completes, a spawned thread corresponding to the completed asynchronous operation calls back itself into a request context of the main request. The spawned thread stores the content corresponding to the completed asynchronous operation at the application server if the completed asynchronous operation is not corresponding to the first placeholder. Otherwise, the spawned thread aggregates and sends a partial response content to the client up to the next unfilled placeholder. This removes the need of the main request processing thread to wait for every operation to finish and hence the main request processing thread is free to handle more requests from other clients rather than waiting for the aggregation of the asynchronous operation to complete.

The present invention may take the form of an entirely hardware embodiment, an entirely software embodiment or an embodiment containing both hardware and software elements. In accordance with an embodiment of the present invention, the invention is implemented in software, which includes, but is not limited to firmware, resident software, microcode, etc.

Furthermore, the invention may take the form of a computer program product accessible from a computer-usable or computer-readable medium providing program code for use by or in connection with a computer or any instruction execution system. For the purposes of this description, a computer-usable or computer readable medium may be any apparatus that may contain, store, communicate, propagate, or transport the program for use by or in connection with the instruction execution system, apparatus or device.

The afore-mentioned medium may be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk-read only memory (CDROM), compact disk-read/write (CD-R/W) and DVD.

In the aforesaid description, specific embodiments of the present invention have been described by way of examples with reference to the accompanying figures and drawings. One of ordinary skill in the art will appreciate that various modifications and changes can be made to the embodiments without departing from the scope of the present invention as set forth in the claims below. Accordingly, the specification and figures are to be regarded in an illustrative rather than a restrictive sense, and all such modifications are intended to be included within the scope of present invention.

What is claimed is:

1. A computer implemented process for processing a request at an application server comprising.
using a computer performing the following series of steps:
initiating one or more asynchronous operations in response to the request;
generating a response content corresponding to the request, wherein the response content comprises one or more placeholders for presenting content corresponding to the one or more asynchronous operations; and
aggregating content received from a completed asynchronous operation by filling the content in the corresponding placeholder; and
sending a partial response content with content up to the first unfilled placeholder.

2. The computer implemented process of claim 1, wherein sending the partial response content is performed at least once before filling all the placeholders.

3. The computer implemented process of claim 1, wherein the request is processed by a main request processing thread.

4. The computer implemented process of claim 1, wherein generating the response content comprises writing an initial content in the response content.

5. The computer implemented process of claim 1, wherein the aggregating the content comprises filling the placeholders in the response content.

6. The computer implemented process of claim 1, wherein the one or more placeholders in the response content are filled in a sequence.

7. The computer implemented process of claim 1 further comprises:
checking if an additional content is required for the response content;
executing a synchronous operation if the additional content requires the synchronous operation; and
writing a synchronous content corresponding to the synchronous operation in the response content.

8. A computer implemented process for processing a request at an application server comprising:
using a computer performing the following series of steps:
generating a response content with an initial content in response to the request;
checking if an additional content is required in the response content;
initiating one or more asynchronous operations if the additional content requires the one or more asynchronous operations;
marking one or more placeholders in the response content corresponding to each of the one or more asynchronous operations; and
in response to completion of each of the one or more asynchronous operations:
aggregating content corresponding to the asynchronous operation at the application server; and
sending a partial the response content with content up to the first unfilled placeholder.

9. The computer implemented process of claim 8, wherein the checking for the additional content further comprises:
executing a synchronous operation if the additional content requires the synchronous operation; and
writing a synchronous content corresponding to the synchronous operation in the response content.

10. A programmable apparatus for processing a request at an application server, comprising:
a programmable hardware connected to a memory;
a program stored in the memory;
wherein the program directs the programmable hardware to perform the following series of steps:
initiating one or more asynchronous operations in response to the request;
generating a response content corresponding to the request, wherein the response content comprises one or more placeholders for presenting content corresponding to the one or more asynchronous operations; and
aggregating content received from a completed asynchronous operation by filling the content in the corresponding placeholder; and
sending a partial response content with content up to the first unfilled placeholder.

11. A computer program product for causing a computer to process a request at an application server, comprising:
a computer readable storage medium;
a program stored in the computer readable storage medium;
wherein the computer readable storage medium, so configured by the program, causes a computer to perform the following series of steps:
initiating one or more asynchronous operations in response to the request;
generating a response content corresponding to the request, wherein the response content comprises one or more placeholders for presenting content corresponding to the one or more asynchronous operations; and
aggregating content received from a completed asynchronous operation by filling the content in the corresponding placeholder; and
sending a partial response content with content up to the first unfilled placeholder.

12. The computer program product of claim 11, wherein the request is processed by a main request processing thread.

13. The computer program product of claim 11, wherein generating the response content comprises writing an initial content in the response content.

14. The computer program product of claim 11, wherein the one or more placeholders in the response content are filled in a sequence.

15. The computer program product of claim 11 further comprises:
checking if an additional content is required for the response content;
executing a synchronous operation if the additional content requires the synchronous operation; and
writing a synchronous content corresponding to the synchronous operation in the response content.
